(19) United States
(12) Patent Application Publication
(10) Pub. No.: US 2019/0081991 A1
(43) Pub. Date: Mar. 14, 2019

(54) SYSTEMS AND METHODS FOR SESSION INITIATION PROTOCOL COMMUNICATION

(71) Applicant: QUALCOMM Incorporated, San Diego, CA (US)

(72) Inventors: Ashwin MURUGESH, Bangalore (IN); Swati SAHA, Bangalore (IN)

(21) Appl. No.: 15/699,656

(22) Filed: Sep. 8, 2017

(51) Int. Cl. H04L 29/06

(52) U.S. Cl. CPC H04L 65/1006; H04L 5/0055; H04L 65/1016; H04L 65/1069

(57) ABSTRACT

Systems and methods may facilitate Session Initiation Protocol communication. A first Session Initiation Protocol INVITE message for a first Session Initiation Protocol dialog may be received. A second Session Initiation Protocol INVITE message for a second Session Initiation Protocol dialog other than the first Session Initiation Protocol dialog may be received. Based on an initiator of the first Session Initiation Protocol INVITE message being an initiator of the second Session Initiation Protocol INVITE message, one or more acts may be performed, such as, sending one or more Session Initiation Protocol messages configured to terminate the first Session Initiation Protocol dialog, or sending one or more Session Initiation Protocol messages configured to transition the second Session Initiation Protocol dialog to a confirmed state.

### BACKGROUND

The following relates generally to wireless communication, and more specifically to facilitating Session Initiation Protocol (SIP) communication.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems (e.g., a Long Term Evolution (LTE) system or a New Radio (NR) system). A wireless multiple-access communications system may include a number of base stations or access network nodes, each simultaneously supporting communication for multiple communication devices, which may be otherwise known as user equipment (UE).

Session Initiation Protocol (SIP) is a protocol used to establish a communication session (e.g., a voice call, a video call, or the like), between multiple devices, such a mobile originating UE (also referred to as a calling UE) and a mobile terminating UE (also referred to as a called UE). See, e.g., Internet Engineering Task Force (IETF) Request for Comments (RFC) 3261, “SIP: Session Initiation Protocol”, June 2002, and other SIP-related IETF RFCs.

Session Initiation Protocol defines messages that are sent between UEs, which govern establishment, termination and other elements of the communication session. Internet Protocol Multimedia Subsystem (IMS) is a set of specifications for offering multimedia services using the internet protocol (IP), and Session Initiation Protocol may be used for the signaling to establish the communication session for transporting the multimedia services. However, Applicants have observed that, in some instances, UEs may experience undesirable delay in establishing such communication sessions.

### SUMMARY

A need therefore exists for systems and methods that eliminate or reduce the disadvantages and problems listed above and/or other disadvantages and problems.

One aspect is a method for facilitating Session Initiation Protocol communication. The method may be performed by one or more processors. The method may comprise receiving a first Session Initiation Protocol INVITE message for a first Session Initiation Protocol dialog. The method may also comprise receiving a second Session Initiation Protocol INVITE message for a second Session Initiation Protocol dialog other than the first Session Initiation Protocol dialog. The method may also comprise based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state.

Another aspect is an apparatus for facilitating Session Initiation Protocol communication. The apparatus may comprise one or more processors configured with processor-executable instructions to perform operations. The operations may comprise receiving a first Session Initiation Protocol INVITE message for a first Session Initiation Protocol dialog. The operations may also comprise receiving a second Session Initiation Protocol INVITE message for a second Session Initiation Protocol dialog other than the first Session Initiation Protocol dialog. The operations may also comprise based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state.

Yet another aspect is an apparatus for facilitating Session Initiation Protocol communication. The apparatus may comprise means for receiving a first Session Initiation Protocol INVITE message for a first Session Initiation Protocol dialog. The apparatus may also comprise means for receiving a second Session Initiation Protocol INVITE message for a second Session Initiation Protocol dialog other than the first Session Initiation Protocol dialog. The apparatus may also comprise means for, based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state.

Still another aspect is a non-transitory processor-readable storage medium having stored thereon processor-executable instructions configured to cause a processor to perform operations. The operations may comprise receiving a first Session Initiation Protocol INVITE message for a first Session Initiation Protocol dialog. The operations may also comprise receiving a second Session Initiation Protocol INVITE message for a second Session Initiation Protocol dialog other than the first Session Initiation Protocol dialog. The operations may also comprise based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state.

For purposes of summarizing, some aspects, advantages and features of a few of the embodiments of the invention have been described in this summary. Some embodiments of the invention may include some or all of these summarized aspects, advantages and features. However, not necessarily all of (or any of) these summarized aspects, advantages or features will be embodied in any particular embodiment of the invention. Thus, none of these summarized aspects, advantages and features are essential. Some of these summarized aspects, advantages and features and other aspects, advantages and features may become more fully apparent from the following detailed description and the appended claims.

### BRIEF DESCRIPTION OF THE DRAWINGS

The appended drawings contain figures of preferred embodiments to further clarify the above and other aspects, advantages and features. It will be appreciated that these drawings depict only preferred embodiments of the invention and are not intended to limit its scope. These preferred embodiments will be described and explained with additional specificity and detail through the use of the accompanying drawings in which:

FIG. 1 illustrates a communication call flow according to some embodiments;

FIG. 2 illustrates a communication call flow according to some embodiments;

FIG. 3 illustrates a communication call flow according to some embodiments;

FIG. 4 illustrates a communication call flow according to some embodiments;

FIG. 5 is a flowchart illustrating an embodiment method for facilitating Session Initiation Protocol communication;

FIG. 6 is a flowchart illustrating an embodiment method for facilitating Session Initiation Protocol communication; and

FIG. 7 is a diagram illustrating an embodiment of a user equipment.

### DETAILED DESCRIPTION

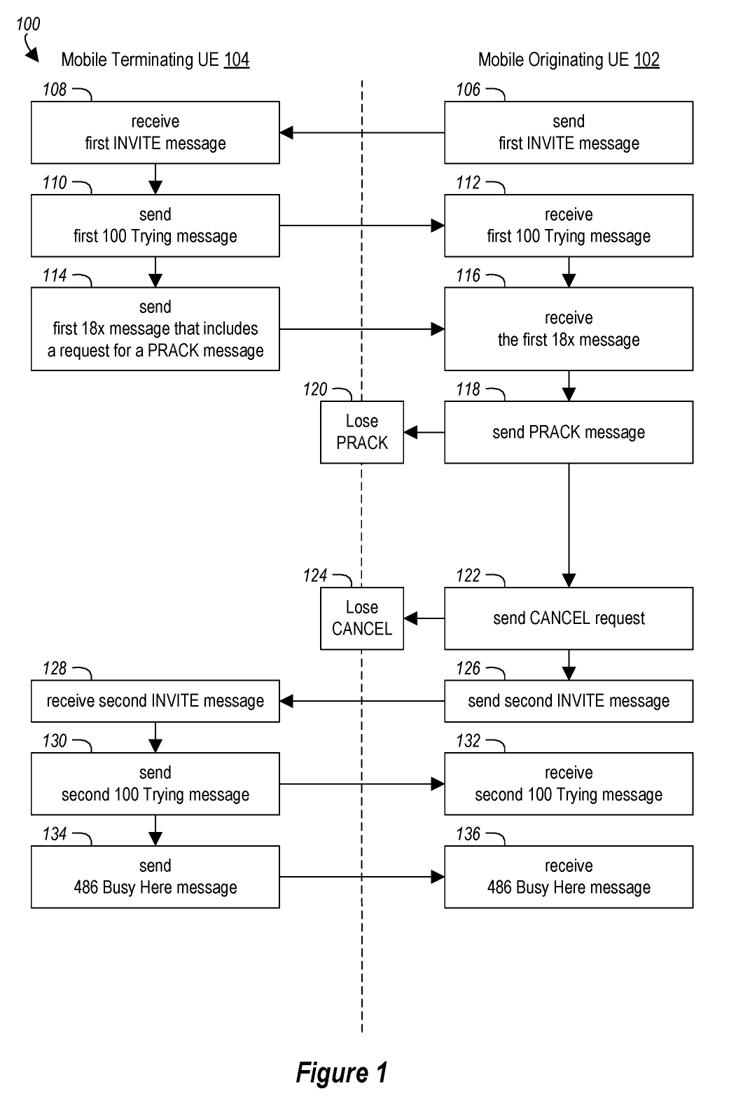

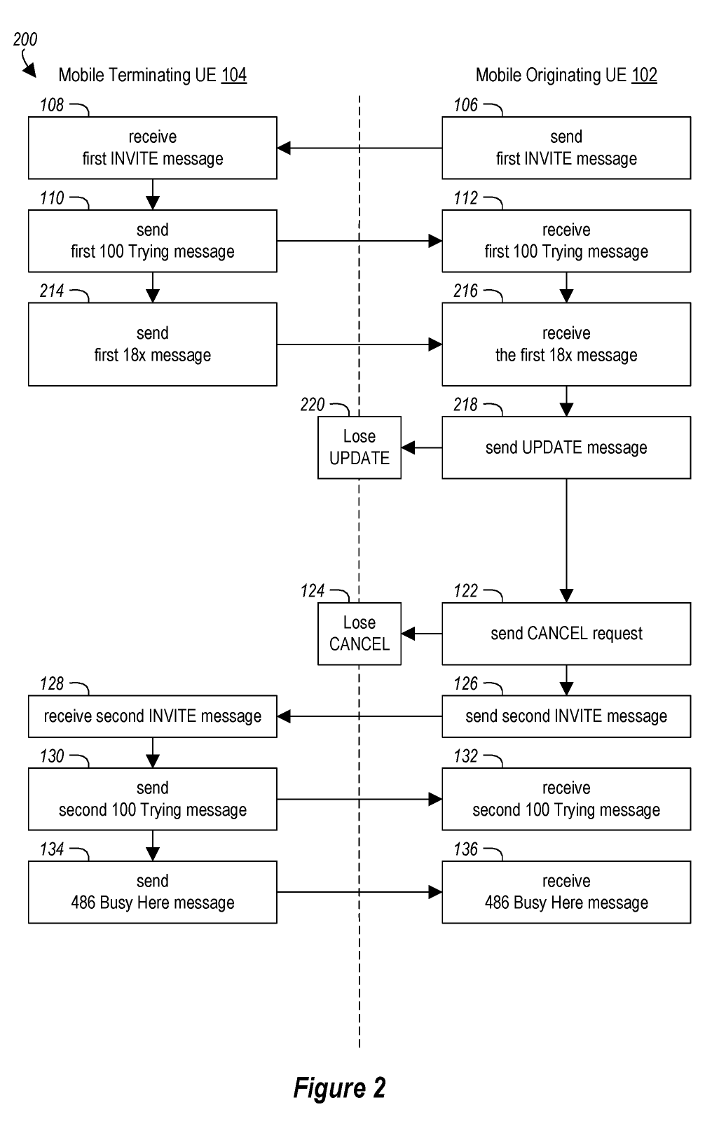

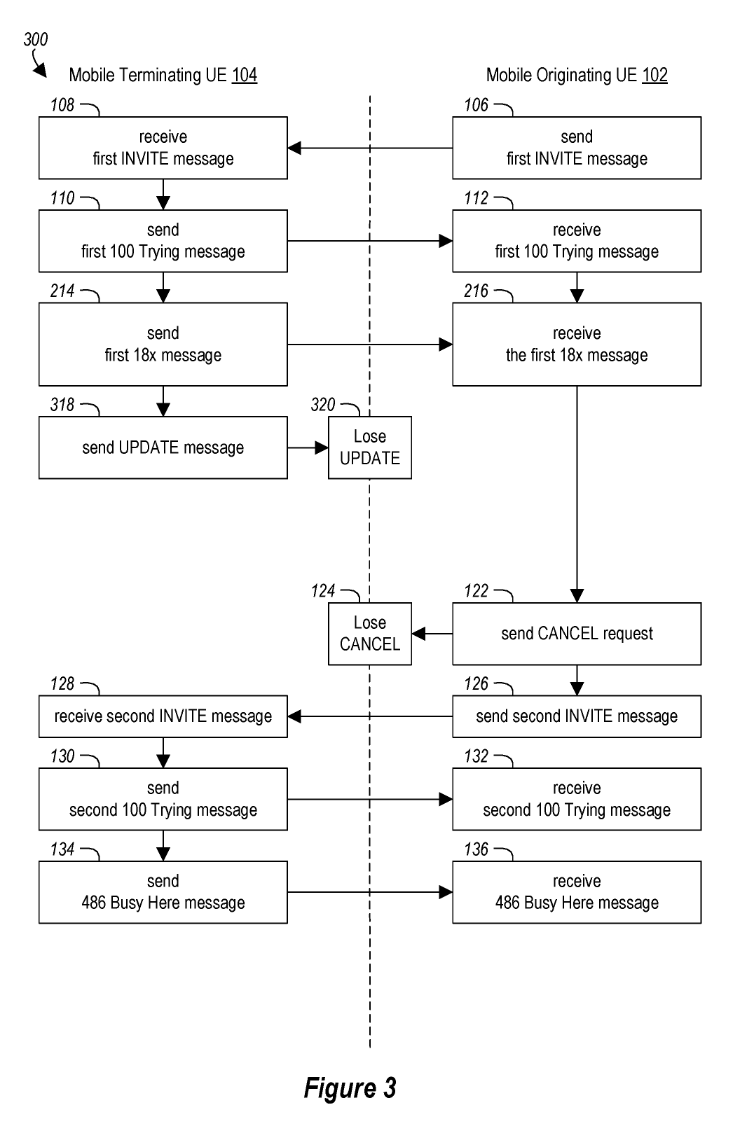

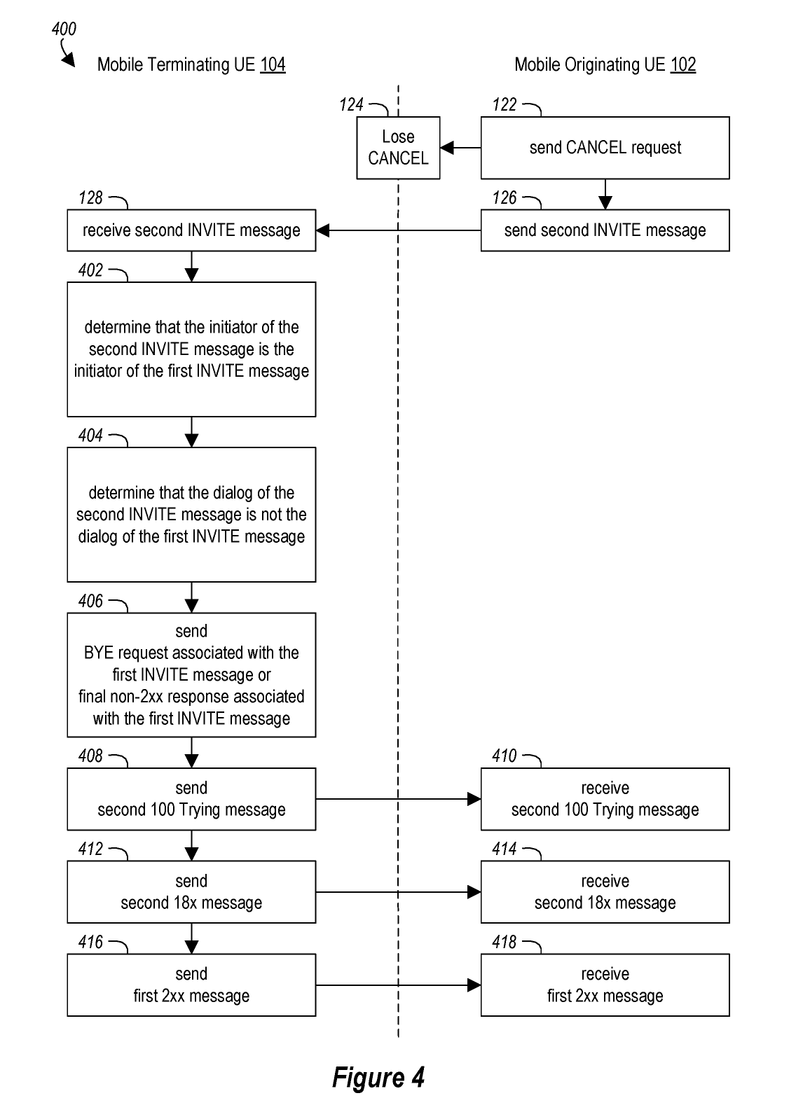

FIG. 1, FIG. 2, FIG. 3, and FIG. 4 illustrate various communication call flows according to some embodiments. In particular, FIG. 1, FIG. 2, FIG. 3, and FIG. 4 illustrate various communication call flows 100, 200, 300, and 400 in which a mobile originating user equipment (UE) 102 and a mobile terminating user equipment 104 (UE) 104 may communicate using one or more wireless communication systems (such as, CDMA systems, TDMA systems, OFDMA systems, LTE systems, NR systems, WiFi systems, Bluetooth systems, or any wireless communication systems), one or more wired communication systems, or any combination thereof. In addition, as shown in FIGS. 1-4, the mobile originating user equipment 102 and the mobile terminating user equipment 104 may communicate using Session Initiation Protocol (as discussed in IETF RFC 3261, June 2002; and in other SIP-related IETF RFCs), one or more other protocols, or any combination thereof.

As shown in call flow 100 in FIG. 1, the mobile originating user equipment 102 may send a first Session Initiation Protocol INVITE message for a first Session Initiation Protocol dialog at block 106. The mobile terminating user equipment 104 may receive first Session Initiation Protocol INVITE message at block 108.

The mobile terminating user equipment 104 may send a first Session Initiation Protocol 100 Trying message associated with the first Session Initiation Protocol dialog at block 110. The mobile originating user equipment 102 may receive the first Session Initiation Protocol 100 Trying message at block 112.

At block 114, the mobile terminating user equipment 104 may send a first Session Initiation Protocol 18x message associated with the first Session Initiation Protocol dialog (e.g., a Session Initiation Protocol 180 Ringing message, a Session Initiation Protocol 181 Call Is Being Forwarded message, a Session Initiation Protocol 182 Queued message, or a Session Initiation Protocol 183 Session Progress message). The mobile originating user equipment 102 may receive the first Session Initiation Protocol 18x message at block 116.

As shown in FIG. 1, at block 114, the first Session Initiation Protocol 18x message may include a request for a Session Initiation Protocol Provisional Response Acknowledgement (PRACK) from the initiator of the first Session Initiation Protocol INVITE message. Exemplary embodiments of a request for a Session Initiation Protocol Provisional Response Acknowledgement are discussed in IETF RFC 3262, “Reliability of Provisional Responses in the Session Initiation Protocol (SIP)”, June 2002.

At block 118, the mobile originating user equipment 102 may send the Session Initiation Protocol Provisional Response Acknowledgement, which was requested by the request included in the first Session Initiation Protocol 18x message that was sent at block 114.

Applicants have observed that the mobile terminating user equipment 104 may not receive the Session Initiation Protocol Provisional Response Acknowledgement that was sent by the mobile originating user equipment 102 at block 118. In particular, as shown in FIG. 1, Applicants have observed that one or more wireless communication systems—which may be used by the mobile originating user equipment 102 and/or the mobile terminating user equipment 104—may experience performance degradation and thus lose the Session Initiation Protocol Provisional Response Acknowledgement (e.g., at block 120). During this performance degradation, the mobile originating user equipment 102 and/or the mobile terminating user equipment 104 may also send one or more additional Session Initiation Protocol messages (not shown), which may be lost.

Consequently, Applicants have further observed that the mobile originating user equipment 102 may, at block 122, send a Session Initiation Protocol CANCEL message associated with the first Session Initiation Protocol dialog, which the one or more wireless communication systems may also lose (e.g., at block 124) and which the mobile terminating user equipment 104 may not receive. In some embodiments, at block 122, the mobile originating user equipment 102 may send the Session Initiation Protocol CANCEL message in response to one or more timers expiring, in response to user input (such as, a user hanging up), in response to other factors or conditions, or any combination thereof.

Applicants have also observed that, in such instances as those illustrated in FIG. 1, the mobile originating user equipment 102 may send a second Session Initiation Protocol INVITE message for a second Session Initiation Protocol dialog other than the first Session Initiation Protocol dialog at block 126. The mobile terminating user equipment 104 may receive the second Session Initiation Protocol INVITE message at block 128. The mobile terminating user equipment 104 may send a second Session Initiation Protocol 100 Trying message associated with the second Session Initiation Protocol dialog at block 130, and the mobile originating equipment may receive may receive the second Session Initiation Protocol 100 Trying message at block 132.

Applicants have further observed that, in such instances as those illustrated in FIG. 1, the mobile terminating user equipment 104 may, at block 134, send a Session Initiation Protocol 486 Busy Here message associated with the second Session Initiation Protocol dialog, which is configured to terminate the second Session Initiation Protocol dialog and which the mobile originating user equipment 102 may receive at block 136. In particular, Applicants have observed that, at least partially because the mobile terminating user equipment 104 did not receive the Session Initiation Protocol CANCEL sent by the mobile originating user equipment 102 at block 122, the mobile terminating user equipment 104 may be in the process of continuing to attempt to communicate via the first Session Initiation Protocol dialog and, thus, may terminate the second Session Initiation Protocol dialog.

As shown in call flow 200 in FIG. 2, the mobile originating user equipment 102 may send a first Session Initiation Protocol INVITE message for a first Session Initiation Protocol dialog at block 106. The mobile terminating user equipment 104 may receive first Session Initiation Protocol INVITE message at block 108.

The mobile terminating user equipment 104 may send a first Session Initiation Protocol 100 Trying message associated with the first Session Initiation Protocol dialog at block 110. The mobile originating user equipment 102 may receive the first Session Initiation Protocol 100 Trying message at block 112.

At block 214, the mobile terminating user equipment 104 may send a first Session Initiation Protocol 18x message associated with the first Session Initiation Protocol dialog (e.g., a Session Initiation Protocol 180 Ringing message, a Session Initiation Protocol 181 Call Is Being Forwarded message, a Session Initiation Protocol 182 Queued message, or a Session Initiation Protocol 183 Session Progress message). The mobile originating user equipment 102 may receive the first Session Initiation Protocol 18x message at block 216.

In some instances, the mobile originating user equipment 102 may send a Session Initiation Protocol UPDATE message associated with the first Session Initiation Protocol dialog at block 218. Applicants have observed that the mobile terminating user equipment 104 may not receive the Session Initiation Protocol UPDATE message that was sent by the mobile originating user equipment 102 at block 218. In particular, as shown in FIG. 2, Applicants have observed that one or more wireless communication systems—which may be used by the mobile originating user equipment 102 and/or the mobile terminating user equipment 104—may experience performance degradation and thus lose the Session Initiation Protocol UPDATE message sent by the mobile originating user equipment 102 (e.g., at block 220). During this performance degradation, the mobile originating user equipment 102 and/or the mobile terminating user equipment 104 may also send one or more additional Session Initiation Protocol messages (not shown), which may be lost.

Consequently, Applicants have further observed that the mobile originating user equipment 102 may, at block 122, send a Session Initiation Protocol CANCEL message associated with the first Session Initiation Protocol dialog, which the one or more wireless communication systems may also lose (e.g., at block 124) and which the mobile terminating user equipment 104 may not receive. In some embodiments, at block 122, the mobile originating user equipment 102 may send the Session Initiation Protocol CANCEL message in response to one or more timers expiring, in response to user input (such as, a user hanging up), in response to other factors or conditions, or any combination thereof.

Applicants have also observed that, in such instances as those illustrated in FIG. 2, the mobile originating user equipment 102 may send a second Session Initiation Protocol INVITE message for a second Session Initiation Protocol dialog other than the first Session Initiation Protocol dialog at block 126. The mobile terminating user equipment 104 may receive the second Session Initiation Protocol INVITE message at block 128. The mobile terminating user equipment 104 may send a second Session Initiation Protocol 100 Trying message associated with the second Session Initiation Protocol dialog at block 130, and the mobile originating equipment may receive may receive the second Session Initiation Protocol 100 Trying message at block 132.

Applicants have further observed that, in such instances as those illustrated in FIG. 2, the mobile terminating user equipment 104 may, at block 134, send a Session Initiation Protocol 486 Busy Here message associated with the second Session Initiation Protocol dialog, which is configured to terminate the second Session Initiation Protocol dialog and which the mobile originating user equipment 102 may receive at block 136. In particular, Applicants have observed that, at least partially because the mobile terminating user equipment 104 did not receive the Session Initiation Protocol CANCEL sent by the mobile originating user equipment 102 at block 122, the mobile terminating user equipment 104 may be in the process of continuing to attempt to communicate via the first Session Initiation Protocol dialog and, thus, may terminate the second Session Initiation Protocol dialog.

As shown in call flow 300 in FIG. 3, the mobile originating user equipment 102 may send a first Session Initiation Protocol INVITE message for a first Session Initiation Protocol dialog at block 106. The mobile terminating user equipment 104 may receive first Session Initiation Protocol INVITE message at block 108.

The mobile terminating user equipment 104 may send a first Session Initiation Protocol 100 Trying message associated with the first Session Initiation Protocol dialog at block 110. The mobile originating user equipment 102 may receive the first Session Initiation Protocol 100 Trying message at block 112.

At block 214, the mobile terminating user equipment 104 may send a first Session Initiation Protocol 18x message associated with the first Session Initiation Protocol dialog (e.g., a Session Initiation Protocol 180 Ringing message, a Session Initiation Protocol 181 Call Is Being Forwarded message, a Session Initiation Protocol 182 Queued message, or a Session Initiation Protocol 183 Session Progress message). The mobile originating user equipment 102 may receive the first Session Initiation Protocol 18x message at block 216.

In some instances, the mobile terminating user equipment 104 may send a Session Initiation Protocol UPDATE message associated with the first Session Initiation Protocol dialog at block 318. Applicants have observed that the mobile originating user equipment 102 may not receive the Session Initiation Protocol UPDATE message that was sent by the mobile terminating user equipment 104 at block 318. In particular, as shown in FIG. 3, Applicants have observed that one or more wireless communication systems—which may be used by the mobile originating user equipment 102 and/or the mobile terminating user equipment 104—may experience performance degradation and thus lose the Session Initiation Protocol UPDATE message sent by the mobile terminating user equipment 104 (e.g., at block 320). During this performance degradation, the mobile originating user equipment 102 and/or the mobile terminating user equipment 104 may also send one or more additional Session Initiation Protocol messages (not shown), which may be lost.

Consequently, Applicants have further observed that the mobile originating user equipment 102 may, at block 122, send a Session Initiation Protocol CANCEL message associated with the first Session Initiation Protocol dialog, which the one or more wireless communication systems may also lose (e.g., at block 124) and which the mobile terminating user equipment 104 may not receive. In some embodiments, at block 122, the mobile originating user equipment 102 may send the Session Initiation Protocol CANCEL message in response to one or more timers expiring, in response to user input (such as, a user hanging up), in response to other factors or conditions, or any combination thereof.

Applicants have also observed that, in such instances as those illustrated in FIG. 3, the mobile originating user equipment 102 may send a second Session Initiation Protocol INVITE message for a second Session Initiation Protocol dialog other than the first Session Initiation Protocol dialog at block 126. The mobile terminating user equipment 104 may receive the second Session Initiation Protocol INVITE message at block 128. The mobile terminating user equipment 104 may send a second Session Initiation Protocol 100 Trying message associated with the second Session Initiation Protocol dialog at block 130, and the mobile originating equipment may receive may receive the second Session Initiation Protocol 100 Trying message at block 132.

Applicants have further observed that, in such instances as those illustrated in FIG. 3, the mobile terminating user equipment 104 may, at block 134, send a Session Initiation Protocol 486 Busy Here message associated with the second Session Initiation Protocol dialog, which is configured to terminate the second Session Initiation Protocol dialog and which the mobile originating user equipment 102 may receive at block 136. In particular, Applicants have observed that, at least partially because the mobile terminating user equipment 104 did not receive the Session Initiation Protocol CANCEL sent by the mobile originating user equipment 102 at block 122, the mobile terminating user equipment 104 may be in the process of continuing to attempt to communicate via the first Session Initiation Protocol dialog and, thus, may terminate the second Session Initiation Protocol dialog.

Referring to FIGS. 1-3 above, Applicants have observed that—at least partially because the mobile terminating user equipment 104 did not receive a Session Initiation Protocol CANCEL associated with a first Session Initiation Protocol dialog that was sent by the mobile originating user equipment 102 at block 122 and/or because of other factors or conditions—the mobile terminating user equipment 104 may be in the process of continuing to attempt to communicate via the first Session Initiation Protocol dialog and, thus, may terminate a second Session Initiation Protocol dialog. Applicants have concluded that this termination of the second Session Initiation Protocol dialog in favor of the first Session Initiation Protocol dialog may be undesirable because the mobile originating user equipment 102 has already abandoned the first Session Initiation Protocol dialog. FIG. 4 illustrates call flow 400, which may help avoid this undesirable termination and/or may provide other advantages.

In further detail, as shown in FIG. 4 (as also shown in FIGS. 1-3), the mobile originating user equipment 102 may send a second Session Initiation Protocol INVITE message for a second Session Initiation Protocol dialog other than the first Session Initiation Protocol dialog at block 126, which the mobile terminating user equipment 104 may receive at block 128. However, as shown in FIG. 4, in some instances, the mobile terminating user equipment 104 need not terminate the second Session Initiation Protocol dialog in favor of the first Session Initiation Protocol dialog.

Rather, as shown in FIG. 4, the mobile terminating user equipment 104 may determine that the initiator of the second Session Initiation Protocol INVITE message is the initiator of the first Session Initiation Protocol INVITE message at block 402; may determine that the second Session Initiation Protocol dialog is not the first Session Initiation Protocol dialog at block 404; and may—in response to determining that the initiator of the second Session Initiation Protocol INVITE message is the initiator of the first Session Initiation Protocol INVITE message and determining that the second Session Initiation Protocol dialog is not the first Session Initiation Protocol dialog—send one or more Session Initiation Protocol messages configured to terminate the first Session Initiation Protocol dialog (e.g., block 406) and/or send one or more Session Initiation Protocol messages configured to transition the second Session Initiation Protocol dialog to a confirmed state (e.g., blocks 408, 412, and 416).

As shown in one example in FIG. 4, in response to determining that the initiator of the second Session Initiation Protocol INVITE message is the initiator of the first Session Initiation Protocol INVITE message at block 402 and determining that the second Session Initiation Protocol dialog is not the first Session Initiation Protocol dialog at block 404, the mobile terminating user equipment 104 may, at block 406, send a Session Initiation Protocol BYE request associated with the first INVITE message and/or the first Session Initiation Protocol dialog, a Session Initiation Protocol final non-2xx response associated with the first INVITE message and/or the first Session Initiation Protocol dialog, one or more other Session Initiation Protocol messages configured to terminate the first Session Initiation Protocol dialog, or any combination thereof.

As shown in another example in FIG. 4, in response to determining that the initiator of the second Session Initiation Protocol INVITE message is the initiator of the first Session Initiation Protocol INVITE message at block 402 and determining that the second Session Initiation Protocol dialog is not the first Session Initiation Protocol dialog at block 404, the mobile terminating user equipment 104 may send a second Session Initiation Protocol 100 Trying message associated with second Session Initiation Protocol INVITE message and/or the second Session Initiation Protocol dialog at block 408 (which the mobile originating user equipment may receive at block 410), a second Session Initiation Protocol 18x message associated with second Session Initiation Protocol INVITE message and/or the second Session Initiation Protocol dialog at block 412 (which the mobile originating user equipment may receive at block 414), a first Session Initiation Protocol 2xx message associated with second Session Initiation Protocol INVITE message and/or the second Session Initiation Protocol dialog at block 416 (which the mobile originating user equipment may receive at block 418), one or more other Session Initiation Protocol messages configured to transition the second Session Initiation Protocol dialog to a confirmed state, or any combination thereof.

Thus, as shown in FIG. 4, the mobile terminating user equipment 104 may send one or more Session Initiation Protocol messages configured to terminate the first Session Initiation Protocol dialog, may send one or more Session Initiation Protocol messages configured to transition the second Session Initiation Protocol dialog to a confirmed state, or both. Applicants have observed that this may advantageously allow the mobile originating user equipment 102 and the mobile terminating user equipment 104 to more quickly communicate by avoiding delays that may occur when, as shown in FIGS. 1-3, the mobile terminating user equipment 104 terminates one or more subsequent Session Initiation Protocol dialogs initiated by the mobile originating user equipment 102 in favor of the first Session Initiation Protocol dialog, which the mobile originating user equipment 102 has already abandoned.

In some embodiments, to determine that the initiator of the second Session Initiation Protocol INVITE message is the initiator of the first Session Initiation Protocol INVITE message at block 402 in FIG. 4, the mobile terminating user equipment 104 may compare one or more fields and/or portions of fields in the first Session Initiation Protocol INVITE message and the second Session Initiation Protocol INVITE message (such as, a P-Asserted-Identity header field discussed in IETF RFC 3325, “Private Extensions to the Session Initiation Protocol (SIP) for Asserted Identity within Trusted Networks”, November 2002; a From header field discussed in IETF RFC 3261, “SIP: Session Initiation Protocol”, June 2002; other suitable Session Initiation Protocol fields and/or portions of such fields, or any combination thereof).

In some embodiments, to determine that the second Session Initiation Protocol dialog is not the first Session Initiation Protocol dialog at block 404 in FIG. 4, the mobile terminating user equipment 104 may compare one or more fields and/or portions of fields in the first Session Initiation Protocol INVITE message and the second Session Initiation Protocol INVITE message (such as, a CSeq header field discussed in IETF RFC 3261, “SIP: Session Initiation Protocol”, June 2002; a Call-ID header field discussed in IETF RFC 3261, “SIP: Session Initiation Protocol”, June 2002; a branch parameter in a Via header field discussed in IETF RFC 3261, “SIP: Session Initiation Protocol”, June 2002; other suitable Session Initiation Protocol fields and/or portions of such fields; or any combination thereof).

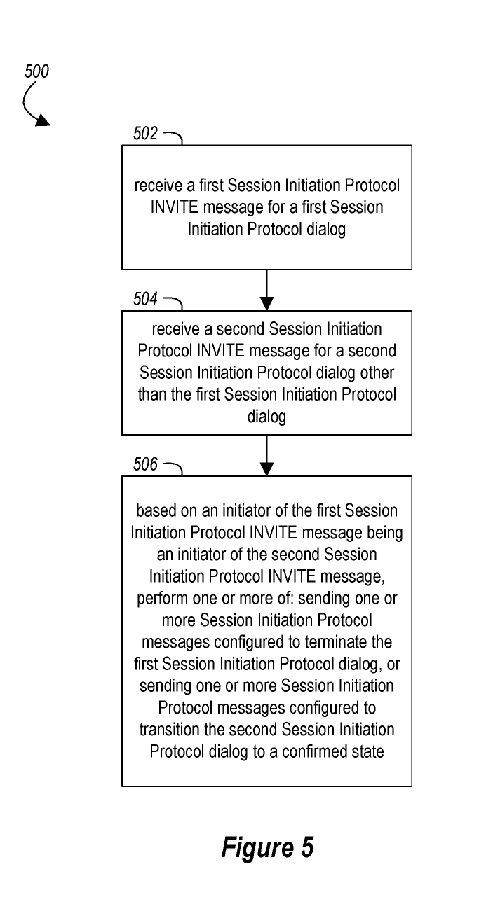

FIG. 5 is a flowchart illustrating an embodiment method 500 for facilitating Session Initiation Protocol communication, which may be performed by one or more processors of a user equipment, such as one or more processors of the mobile terminating user equipment 104. As shown in FIG. 5, the method 500 may include one or more blocks, such as blocks 502, 504, and 506.

At block 502, the processor may receive a first Session Initiation Protocol INVITE message for a first Session Initiation Protocol dialog. For example, in some embodiments at block 502, the processor may receive a first Session Initiation Protocol INVITE message for a first Session Initiation Protocol dialog, for example, as illustrated by block 108 shown in FIGS. 1-4.

At block 504, the processor may receive a second Session Initiation Protocol INVITE message for a second Session Initiation Protocol dialog other than the first Session Initiation Protocol dialog. For example, in some embodiments at block 504, the processor may receive a second Session Initiation Protocol INVITE message for a second Session Initiation Protocol dialog other than the first Session Initiation Protocol dialog, for example, as illustrated by block 128 shown in FIGS. 1-4.

In some embodiments, at block 504, the processor may receive the second Session Initiation Protocol INVITE message without having received a Session Initiation Protocol CANCEL message associated with the first Session Initiation Protocol dialog that was sent by the initiator of the first Session Initiation Protocol INVITE message, for example, as illustrated by block 128 shown in FIGS. 1-3.

In some instances, at block 504, the processor may receive the second Session Initiation Protocol INVITE message without the first Session Initiation Protocol dialog having been transitioned to a confirmed state, for example, as illustrated by block 128 shown in FIGS. 1-3. However, in some instances, at block 504, the processor may receive the second Session Initiation Protocol INVITE message the second Session Initiation Protocol INVITE message after the first Session Initiation Protocol dialog has been transitioned to a confirmed state.

In some embodiments, the processor may send a Session Initiation Protocol message that is associated with the first Session Initiation Protocol dialog and that includes a request for a Session Initiation Protocol Provisional Response Acknowledgement from the initiator of the first Session Initiation Protocol INVITE message, for example, as illustrated by block 114 in FIG. 1. In such embodiments, at block 504, the processor may receive the second Session Initiation Protocol INVITE message without having received the Session Initiation Protocol Provisional Response Acknowledgement from the initiator of the first Session Initiation Protocol INVITE message, which was requested by the request, for example, as illustrated by block 128 in FIG. 1.

In some embodiments, at block 504, the processor may receive the second Session Initiation Protocol INVITE message without having received a Session Initiation Protocol UPDATE message associated with the first Session Initiation Protocol dialog that was sent by the initiator of the first Session Initiation Protocol INVITE message, for example, as illustrated by block 128 in FIG. 2.

In some embodiments, the processor may send a Session Initiation Protocol UPDATE message associated with the first Session Initiation Protocol dialog, for example, as illustrated in block 318 in FIG. 3. In such embodiments, at block 504, the processor may receive the second Session Initiation Protocol INVITE message without having received, from the initiator of the first Session Initiation Protocol INVITE message, a Session Initiation Protocol message responding to the Session Initiation Protocol UPDATE message, for example, as illustrated in block 128 in FIG. 3.

At block 506, the processor may, based on an initiator of the first Session Initiation Protocol INVITE message being an initiator of the second Session Initiation Protocol INVITE message, perform one or more of: sending one or more Session Initiation Protocol messages configured to terminate the first Session Initiation Protocol dialog, or sending one or more Session Initiation Protocol messages configured to transition the second Session Initiation Protocol dialog to a confirmed state. Thus, in some embodiments at block 506, the processor may, based on an initiator of the first Session Initiation Protocol INVITE message being an initiator of the second Session Initiation Protocol INVITE message, send one or more Session Initiation Protocol messages configured to terminate the first Session Initiation Protocol dialog, one or more Session Initiation Protocol messages configured to transition the second Session Initiation Protocol dialog to a confirmed state, or both.

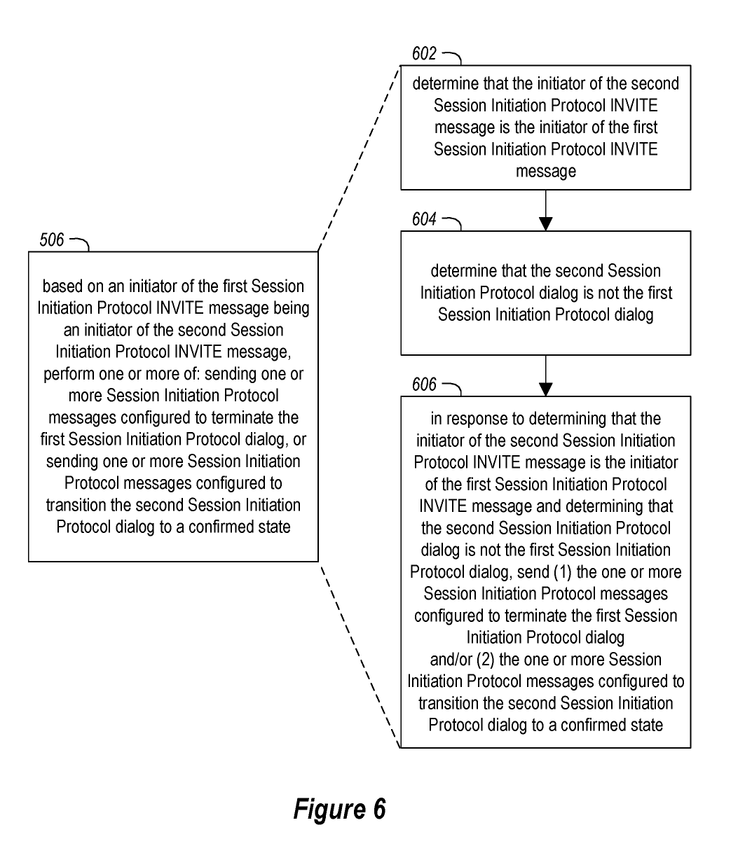

As shown in FIG. 6, in some embodiments, block 506 (FIG. 5) may include one or more blocks, such as, blocks 602, 604, and 606, which may be performed by one or more processors of a user equipment, such as one or more processors of the mobile terminating user equipment 104.

At block 602, the processor may determine that the initiator of the second Session Initiation Protocol INVITE message is the initiator of the first Session Initiation Protocol INVITE message, for example, as illustrated by block 402 in FIG. 4.

At block 604, the processor may determine that the second Session Initiation Protocol dialog is not the first Session Initiation Protocol dialog, for example, as illustrated by block 404 in FIG. 4.

At block 606, the processor may, in response to determining that the initiator of the second Session Initiation Protocol INVITE message is the initiator of the first Session Initiation Protocol INVITE message at block 602 and determining that the second Session Initiation Protocol dialog is not the first Session Initiation Protocol dialog at block 604, send the one or more Session Initiation Protocol messages configured to terminate the first Session Initiation Protocol dialog, the one or more Session Initiation Protocol messages configured to transition the second Session Initiation Protocol dialog to a confirmed state, or both.

In some embodiments at block 606, the one or more Session Initiation Protocol messages configured to terminate the first Session Initiation Protocol dialog may include a Session Initiation Protocol BYE request associated with the first INVITE message and/or the first Session Initiation Protocol dialog (for example as illustrated by block 406 of FIG. 4), a Session Initiation Protocol final non-2xx response associated with the first INVITE message and/or the first Session Initiation Protocol dialog (for example as illustrated by block 406 of FIG. 4), one or more other Session Initiation Protocol messages configured to terminate the first Session Initiation Protocol dialog, or any combination thereof.

In some embodiments at block 606, the one or more Session Initiation Protocol messages configured to transition the second Session Initiation Protocol dialog to a confirmed state may include a second Session Initiation Protocol 100 Trying message associated with second Session Initiation Protocol INVITE message and/or the second Session Initiation Protocol dialog (for example as illustrated by block 408 of FIG. 4), a second Session Initiation Protocol 18x message associated with second Session Initiation Protocol INVITE message and/or the second Session Initiation Protocol dialog (for example as illustrated by block 412 of FIG. 4), a first Session Initiation Protocol 2xx message associated with second Session Initiation Protocol INVITE message and/or the second Session Initiation Protocol dialog (for example as illustrated by block 416 of FIG. 4), one or more other Session Initiation Protocol messages configured to transition the second Session Initiation Protocol dialog to a confirmed state, or any combination thereof.

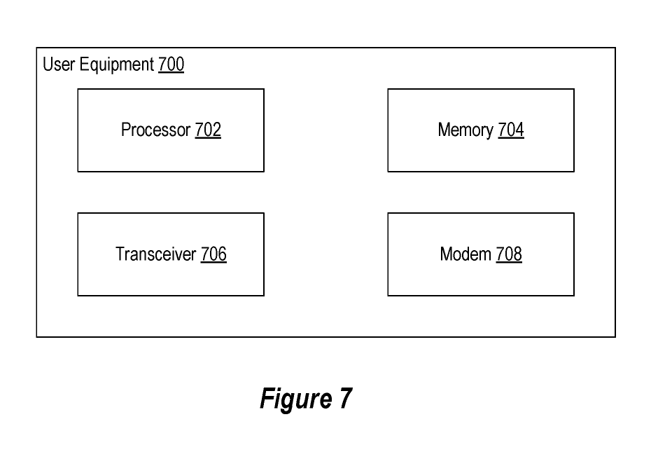

Various embodiments (including, but not limited to, embodiments discussed above with reference to FIGS. 1-6) may be implemented in any user equipment, one example of which is illustrated in FIG. 7. For example, the user equipment 700 may include one or more processors 702 coupled to a touch screen controller and one or more internal memory 704. The processor 702 may be one or more multicore integrated circuits designated for general or specific processing tasks. The internal memory 704 may be volatile or non-volatile memory, and may also be secure and/or encrypted memory, or unsecure and/or unencrypted memory, or any combination thereof. The touch screen controller and the processor 702 may also be coupled to a touch screen panel, such as a resistive-sensing touch screen, capacitive-sensing touch screen, infrared sensing touch screen, etc. The user equipment 700 may have one or more radio signal transceivers 706 (e.g., Peanut®, Bluetooth®, Zigbee®, Wi-Fi, RF, cellular, etc.) and antennae, for sending and receiving, coupled to each other and/or to the processor 702. The transceiver 706 and antennae may be used with the above-mentioned circuitry to implement the various wireless transmission protocol stacks and interfaces. The user equipment 700 may include one or more cellular network wireless modem chips 708 that enable communication via one or more cellular networks and that are coupled to the processor.

The user equipment 700 may include a peripheral device connection interface coupled to the processor 702. The peripheral device connection interface may be singularly configured to accept one type of connection, or multiply configured to accept various types of physical and communication connections, common or proprietary, such as USB, FireWire, Thunderbolt, Ethernet, or PCIe. The peripheral device connection interface may also be coupled to a similarly configured peripheral device connection port. The user equipment 700 may also include speakers for providing audio outputs.

The user equipment 700 may also include a housing—which may be constructed of plastic, metal, one or more other materials, or a combination of thereof—for containing all or some of the components discussed herein. The user equipment 700 may include a power source coupled to the processor 702, such as a disposable or rechargeable battery. The rechargeable battery may also be coupled to the peripheral device connection port to receive a charging current from a source external to the user equipment 700.

The processor 702 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processor 702. The processor 702 and may include internal memory sufficient to store the application software instructions. In many devices, the internal memory may be a volatile or nonvolatile memory, such as flash memory, or a mixture of both. For the purposes of this description, a general reference to memory refers to memory accessible by the processor 702 including internal memory or removable memory plugged into the device and memory within the processor 702 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The methods and systems described above require no particular component or function. Thus, any described component or function—despite its advantages—is optional. Also, some or all of the described components and functions described above may be used in connection with any number of other suitable components and functions.

Although the exemplary embodiments discussed above have been described with respect to Session Initiation Protocol, these aspects and features may also be used in connection with other types of protocols.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

Moreover, although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method for facilitating Session Initiation Protocol communication, the method comprising:
by one or more processors:
receiving a first Session Initiation Protocol INVITE message for a first Session Initiation Protocol dialog;
receiving a second Session Initiation Protocol INVITE message for a second Session Initiation Protocol dialog other than the first Session Initiation Protocol dialog; and
based on an initiator of the first Session Initiation Protocol INVITE message being an initiator of the second Session Initiation Protocol INVITE message, performing one or more of:
sending one or more Session Initiation Protocol messages configured to terminate the first Session Initiation Protocol dialog, or
sending one or more Session Initiation Protocol messages configured to transition the second Session Initiation Protocol dialog to a confirmed state.

2. The method of claim 1, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
based on the initiator of the first Session Initiation Protocol INVITE message being the initiator of the second Session Initiation Protocol INVITE message, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.

3. The method of claim 1, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending the one or more Session Initiation Protocol messages configured to terminate the first Session Initiation Protocol dialog.

4. The method of claim 1, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending the one or more Session Initiation Protocol messages configured to transition the second Session Initiation Protocol dialog to a confirmed state.

5. The method of claim 1, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.

6. The method of claim 1, wherein receiving a second Session Initiation Protocol INVITE message comprises:
receiving the second Session Initiation Protocol INVITE message without having received a Session Initiation Protocol CANCEL message associated with the first Session Initiation Protocol dialog that was sent by the initiator of the first Session Initiation Protocol INVITE message.

7. The method of claim 1, wherein receiving a second Session Initiation Protocol INVITE message comprises:
receiving the second Session Initiation Protocol INVITE message without the first Session Initiation Protocol dialog having been transitioned to a confirmed state.

8. The method of claim 1, wherein receiving a second Session Initiation Protocol INVITE message comprises:
receiving the second Session Initiation Protocol INVITE message after the first Session Initiation Protocol dialog has been transitioned to a confirmed state.

9. The method of claim 1, further comprising:
by the one or more processors:
sending a Session Initiation Protocol message that is associated with the first Session Initiation Protocol dialog and that includes a request for a Session Initiation Protocol Provisional Response Acknowledgement from the initiator of the first Session Initiation Protocol INVITE message;
wherein receiving a second Session Initiation Protocol INVITE message comprises:
receiving the second Session Initiation Protocol INVITE message without having received the Session Initiation Protocol Provisional Response Acknowledgement from the initiator of the first Session Initiation Protocol INVITE message, which was requested by the request.

10. The method of claim 1, wherein receiving a second Session Initiation Protocol INVITE message comprises:
receiving the second Session Initiation Protocol INVITE message without having received a Session Initiation Protocol UPDATE message associated with the first Session Initiation Protocol dialog that was sent by the initiator of the first Session Initiation Protocol INVITE message.

11. The method of claim 1, further comprising:
by the one or more processors:
sending a Session Initiation Protocol UPDATE message associated with the first Session Initiation Protocol dialog;
wherein receiving a second Session Initiation Protocol INVITE message comprises:
receiving the second Session Initiation Protocol INVITE message without having received, from the initiator of the first Session Initiation Protocol INVITE message, a Session Initiation Protocol message responding to the Session Initiation Protocol UPDATE message.

12. An apparatus for facilitating Session Initiation Protocol communication, the apparatus comprising:
one or more processors configured with processor-executable instructions to perform operations comprising:
receiving a first Session Initiation Protocol INVITE message for a first Session Initiation Protocol dialog;
receiving a second Session Initiation Protocol INVITE message for a second Session Initiation Protocol dialog other than the first Session Initiation Protocol dialog; and
based on an initiator of the first Session Initiation Protocol INVITE message being an initiator of the second Session Initiation Protocol INVITE message, performing one or more of:
sending one or more Session Initiation Protocol messages configured to terminate the first Session Initiation Protocol dialog, or
sending one or more Session Initiation Protocol messages configured to transition the second Session Initiation Protocol dialog to a confirmed state.

13. The apparatus of claim 12, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
based on the initiator of the first Session Initiation Protocol INVITE message being the initiator of the second Session Initiation Protocol INVITE message, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.

14. The apparatus of claim 12, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending the one or more Session Initiation Protocol messages configured to terminate the first Session Initiation Protocol dialog.

15. The apparatus of claim 12, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending the one or more Session Initiation Protocol messages configured to transition the second Session Initiation Protocol dialog to a confirmed state.

16. The apparatus of claim 12, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.

17. The apparatus of claim 12, wherein receiving a second Session Initiation Protocol INVITE message comprises:
receiving the second Session Initiation Protocol INVITE message without having received a Session Initiation Protocol CANCEL message associated with the first Session Initiation Protocol dialog that was sent by the initiator of the first Session Initiation Protocol INVITE message.

18. The apparatus of claim 12, wherein receiving a second Session Initiation Protocol INVITE message comprises:
receiving the second Session Initiation Protocol INVITE message without the first Session Initiation Protocol dialog having been transitioned to a confirmed state.

19. The apparatus of claim 12, wherein receiving a second Session Initiation Protocol INVITE message comprises:
receiving the second Session Initiation Protocol INVITE message after the first Session Initiation Protocol dialog has been transitioned to a confirmed state.

20. The apparatus of claim 12, wherein the operations further comprise:
sending a Session Initiation Protocol message that is associated with the first Session Initiation Protocol dialog and that includes a request for a Session Initiation Protocol Provisional Response Acknowledgement from the initiator of the first Session Initiation Protocol INVITE message;
wherein receiving a second Session Initiation Protocol INVITE message comprises:
receiving the second Session Initiation Protocol INVITE message without having received the Session Initiation Protocol Provisional Response Acknowledgement from the initiator of the first Session Initiation Protocol INVITE message, which was requested by the request.

21. The apparatus of claim 12, wherein receiving a second Session Initiation Protocol INVITE message comprises:
receiving the second Session Initiation Protocol INVITE message without having received a Session Initiation Protocol UPDATE message associated with the first Session Initiation Protocol dialog that was sent by the initiator of the first Session Initiation Protocol INVITE message.

22. The apparatus of claim 12, wherein the operations further comprise:
sending a Session Initiation Protocol UPDATE message associated with the first Session Initiation Protocol dialog;
wherein receiving a second Session Initiation Protocol INVITE message comprises:
receiving the second Session Initiation Protocol INVITE message without having received, from the initiator of the first Session Initiation Protocol INVITE message, a Session Initiation Protocol message responding to the Session Initiation Protocol UPDATE message.

23. An apparatus for facilitating Session Initiation Protocol communication, the apparatus comprising:
means for receiving a first Session Initiation Protocol INVITE message for a first Session Initiation Protocol dialog;
means for receiving a second Session Initiation Protocol INVITE message for a second Session Initiation Protocol dialog other than the first Session Initiation Protocol dialog; and
means for, based on an initiator of the first Session Initiation Protocol INVITE message being an initiator of the second Session Initiation Protocol INVITE message, performing one or more of:
sending one or more Session Initiation Protocol messages configured to terminate the first Session Initiation Protocol dialog, or
sending one or more Session Initiation Protocol messages configured to transition the second Session Initiation Protocol dialog to a confirmed state.

24. A non-transitory processor-readable storage medium having stored thereon processor-executable instructions configured to cause a processor to perform operations comprising:
receiving a first Session Initiation Protocol INVITE message for a first Session Initiation Protocol dialog;
receiving a second Session Initiation Protocol INVITE message for a second Session Initiation Protocol dialog other than the first Session Initiation Protocol dialog; and
based on an initiator of the first Session Initiation Protocol INVITE message being an initiator of the second Session Initiation Protocol INVITE message, performing one or more of:
sending one or more Session Initiation Protocol messages configured to terminate the first Session Initiation Protocol dialog, or
sending one or more Session Initiation Protocol messages configured to transition the second Session Initiation Protocol dialog to a confirmed state.

25. The non-transitory processor-readable storage medium of claim 24, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
based on the initiator of the first Session Initiation Protocol INVITE message being the initiator of the second Session Initiation Protocol INVITE message, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.

26. The non-transitory processor-readable storage medium of claim 24, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
based on the initiator of the first Session Initiation Protocol INVITE message being the initiator of the second Session Initiation Protocol INVITE message, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.

27. The non-transitory processor-readable storage medium of claim 24, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending the one or more Session Initiation Protocol messages configured to terminate the first Session Initiation Protocol dialog.

28. The non-transitory processor-readable storage medium of claim 24, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending the one or more Session Initiation Protocol messages configured to transition the second Session Initiation Protocol dialog to a confirmed state.

29. The non-transitory processor-readable storage medium of claim 24, wherein based on an initiator of the first Session Initiation Protocol INVITE message being an initiator of the second Session Initiation Protocol INVITE message, performing one or more of: sending one or more Session Initiation Protocol messages configured to terminate the first Session Initiation Protocol dialog, or sending one or more Session Initiation Protocol messages configured to transition the second Session Initiation Protocol dialog to a confirmed state, comprises:
determining that the initiator of the second Session Initiation Protocol INVITE message is the initiator of the first Session Initiation Protocol INVITE message;
determining that the second Session Initiation Protocol dialog is not the first Session Initiation Protocol dialog; and
in response to determining that the initiator of the second Session Initiation Protocol INVITE message is the initiator of the first Session Initiation Protocol INVITE message and determining that the second Session Initiation Protocol dialog is not the first Session Initiation Protocol dialog, sending (1) the one or more Session Initiation Protocol messages configured to terminate the first Session Initiation Protocol dialog and (2) the one or more Session Initiation Protocol messages configured to transition the second Session Initiation Protocol dialog to a confirmed state.
